(19) United States
(12) Patent Application Publication
(10) Pub. No.: US 2007/0086386 A1
(43) Pub. Date: Apr. 19, 2007

(54) Method and apparatus for supporting seamless handover in transport layer

(75) Inventors: Kyung-Joo Suh, Seoul (KR); Soon-Young Yoon, Seoul (KR); Jae-Hee Cho, Seoul (KR); In-Seok Hwang, Seoul (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/581,838

(22) Filed: Oct. 17, 2006

(30) Foreign Application Priority Data
Oct. 17, 2005 (KR) 2005-0097787

(51) Int. Cl. H04Q 7/00

(52) U.S. Cl. 370/331

(57) ABSTRACT

A method and apparatus for supporting a seamless handover in a transport layer is provided. In a network using an SCTP, an MN notifies a CN of a handover after the handover occurs. The MN receives a handover confirm message from the CN and sends a response message for the handover confirm message to the CN. The MN checks a recipient IP address at which data is received from the CN. If the recipient IP address is a new IP address, the MN changes a primary IP address of the MN to the new IP address. If the recipient IP address is the primary IP address, the MN maintains the primary IP address.

### PRIORITY

This application claims priority under 35 U.S.C. § 119 to an application filed in the Korean Intellectual Property Office on Oct. 17, 2005 and assigned Serial No. 2005-97787, the contents of which are incorporated herein by reference.

### BACKGROUND OF THE INVENTION

1. Field of the Invention

The present invention relates generally to a handover supporting method and apparatus, and in particular, to a method and apparatus for supporting a seamless handover for a Mobile Node (MN) in a transport layer.

2. Description of the Related Art

Wireless Internet connectivity based on Wireless Local Area Network (WLAN), Bluetooth, or infrared communications is rapidly replacing wired Internet connectivity provided to offices and schools or provided by commercial services.

As wireless communications enables mobility, specific studies have been conducted on mobility, and the Internet technology standardization body, the Internet Engineering Task Force (IETF), has presented Mobile Internet Protocol (IP) to support mobility.

Mobile IP has been specified as Mobile IP version 4 (IPv4) and Mobile IP version 6 (IPv6) according to its versions.

If an MN moves from one network to another while communicating with a particular Correspondent Node (CN), its IP address is supposed to change. Yet, Mobile IP is a network-layer protocol for supporting mobility from a macro point of view by enabling seamless on-going communications without changing the IP address of the MN.

Mobility in the network layer is distinguished from mobility in the data link layer. Especially the data link layer-mobility, for example, in WLAN is mobility between Access Points (APs) in a data link layer protocol such as the Institute of Electrical and Electronics Engineers (IEEE) 802.11a/b/g standard.

However, a drawback with Mobile IP is that depending on its version, Mobile IP requires routers equipped with particular agent functions like a Home Agent (HA) or a Foreign Agent (FA) to support mobility across networks and carries out IP tunneling and packet buffering to deliver packets to the handover MN, thus bringing about excess overhead.

Compared to Mobile IP supporting mobility in the network layer, the IETF has developed Stream Control Transmission Protocol (SCTP) and mobile SCTP (mSCTP) to support mobility in the transport layer.

Unlike Mobile IP, SCTP and mSCTP support multi-homing for transport-layer mobility. Multi-homing is a technique for using a plurality of IP addresses for one or more Network Interface Cards (NICs). That is, the use of a plurality of IP addresses is supported for an MN's handover.

Real implementation of multi-homing is relatively easy because support of the multi-homing technology at end-to-end nodes suffices without the need of a particular agent. Despite this advantage, multi-homing is now at an early developmental stage for building an overall framework, with no consideration given to seamless handover for the MN.

Typically, the MN suffers from communication interruptions and data loss due to a time delay during handover. Yet, seamless handover offers the benefit of relatively small data loss during handover.

FIG. 1 illustrates a conventional transport layer handover operation.

Referring to FIG. 1, an MN 101 attempts a handover from an old network to a new network while communicating with a CN 105 in step 110.

In step 120, the MN 101 (newly denoted by a reference numeral 102) which has moved to the new network, i.e. the MN 102, acquires a new IP address in the new network and sends an Address Configuration Change Chunk (ADD-IP-ASCONF) message to the CN 105.

The ADD-IP-ASCONF message is an SCTP message used to notify the new IP address acquired by the handover.

Upon receipt of the ADD-IP-ASCONF message, the CN 105 replies with an Address Configuration Change Chunk Acknowledgement (ADD-IP-ASCONF-ACK) message in step 130.

Then the CN 105 updates the primary IP address of the MN 102 to the received new IP address in step 135. The primary IP address is a main IP address that the MN 102 uses.

If the MN 102 moves to the old network, the CN 105 cannot send data to the MN 101 without changing IP address, resulting in data loss in step 150. As a consequence, a seamless service is impossible.

### SUMMARY OF THE INVENTION

An object of the present invention is to substantially solve at least the above problems and/or disadvantages and to provide at least the advantages below. Accordingly, an object of the present invention is to provide a handover method and apparatus for minimizing data loss and avoiding communication disconnection in a transport layer.

According to one aspect of the present invention, in a handover method of an MN in a network using an SCTP, the MN notifies a CN of a handover after the handover occurs. The MN receives a handover confirm message from the CN and sends a response message for the handover confirm message to the CN. The MN checks a recipient IP address at which data is received from the CN. If the recipient IP address is a new IP address, the MN changes a primary IP address of the MN to the new IP address. If the recipient IP address is the primary IP address, the MN maintains the primary IP address.

According to another aspect of the present invention, in a handover method in a CN in a network using an SCTP, the CN is notified of a handover by an MN and sends a response message to the MN. The CN sends a handover confirm message to the MN and receives a handover confirm response message for the handover confirm message from the MN. Then the CN sends data to a new IP address of the MN. If a data response message for the data is received from the new IP address, the CN updates a primary IP address of the MN to the new IP address. If the data response message for the data is not received from the new IP address, the CN sends the data to the primary IP address. If a data response message for the data is received from the primary IP address, the CN maintains the primary IP address.

According to a further aspect of the present invention, in a method of transmitting data in a CN in a network using an SCTP, the CN sends data to a new IP address of an MN. Upon receipt of a response message for the data from the MN at the new IP address, the CN updates the IP address of the MN to the new IP address and continues data transmission.

According to still another aspect of the present invention, in a method of setting a primary IP address in a CN in a network using an SCTP, the CN confirms a handover of an MN and sends data to a new IP address of the MN. Upon receipt of a response for the data from the MN at the new IP address, the CN updates a primary IP address of the MN to the new IP address.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a conventional transport layer handover operation;

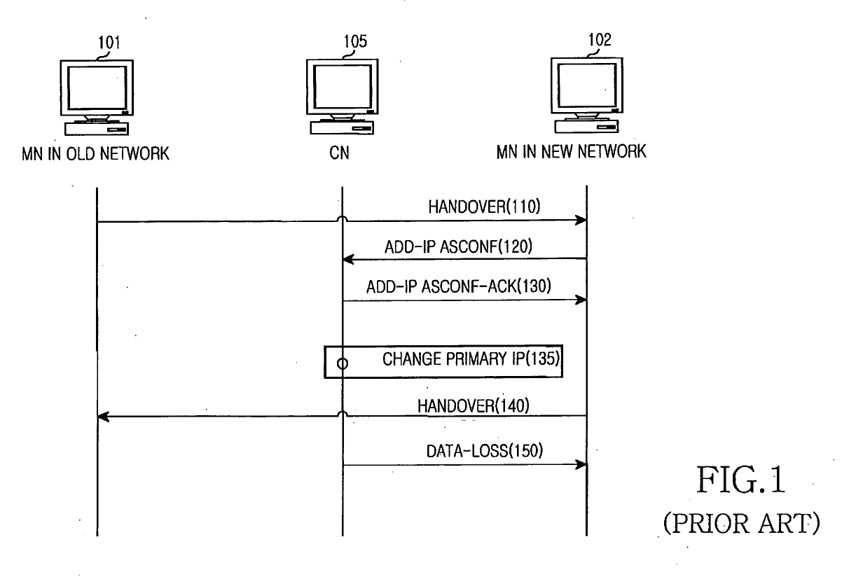

FIG. 2 illustrates a network configuration for data transmission under a seamless handover environment according to the present invention;

FIG. 3 is a flowchart illustrating an MN's operation for data transmission under a seamless handover environment according to the present invention;

FIG. 4 is a flowchart illustrating a CN's operation for data transmission under the seamless handover environment according to the present invention;

FIG. 5 illustrates the structure of a HANDOVER-CONF message according to the present invention;

FIG. 6 illustrates the structure of a HANDOVER-CONF-ACK message according to the present invention; and

FIG. 7 illustrates a handover operation for data transmission under the seamless handover environment according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a method of supporting a seamless handover in a transport layer.

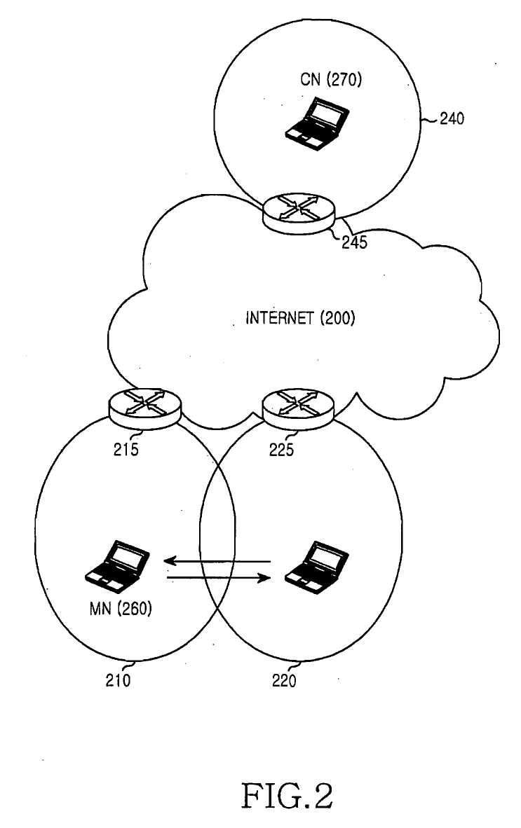

FIG. 2 illustrates a network configuration for data transmission under a seamless handover environment according to the present invention.

Referring to FIG. 2, a CN 270 is an end node in communication with an MN 260 by SCTP/IP over Internet 200.

According to the present invention, it is assumed that the MN 260 uses a data link layer protocol (e.g. IEEE 802.11a/b/g) supporting wireless communications and routers 215, 225 and 245 each have a wireless communication device (e.g. an AP supporting an IEEE 802.11a/b/g protocol) in addition to a conventional router structure and is thus capable of wireless communication. The wireless communication devices are preferably incorporated into the routers 215, 225 and 245, or may be separately implemented.

The routers 215, 225 and 245 have their unique IP address ranges so that nodes connected to the routers 215, 225 and 245 have unique IP addresses according to their connected routers.

In IPv4, a unique IP address is a public address, not a private address. In IPv6, it is not a local address but a global unicast address.

While not shown, the CN 270 can be connected to the router 245 by cable, instead of being connected wirelessly as shown.

The routers 215, 225 and 245 periodically send advertisement messages announcing their existence to nodes which want to access the routers. The advertisement messages contain the network addresses of the routers 215, 225 and 245. The advertisement messages, which are sent wirelessly with the network addresses of the routers 215, 225 and 245, cover areas 210, 220 and 240, respectively, because of their radio power levels. Nodes within the coverage areas 210, 220 and 240 of the routers 215, 225 and 245 can acquire IP addresses by the periodic advertisement messages.

The IP address acquisition is carried out by Dynamic Host Configuration Protocol (DHCP) in IPv4. In IPv6, a node generates an IP address on its own or acquires an IP address by DHCP as with IPv4. DHCP is a protocol for allocating an IP address to a node by a router or a particular server.

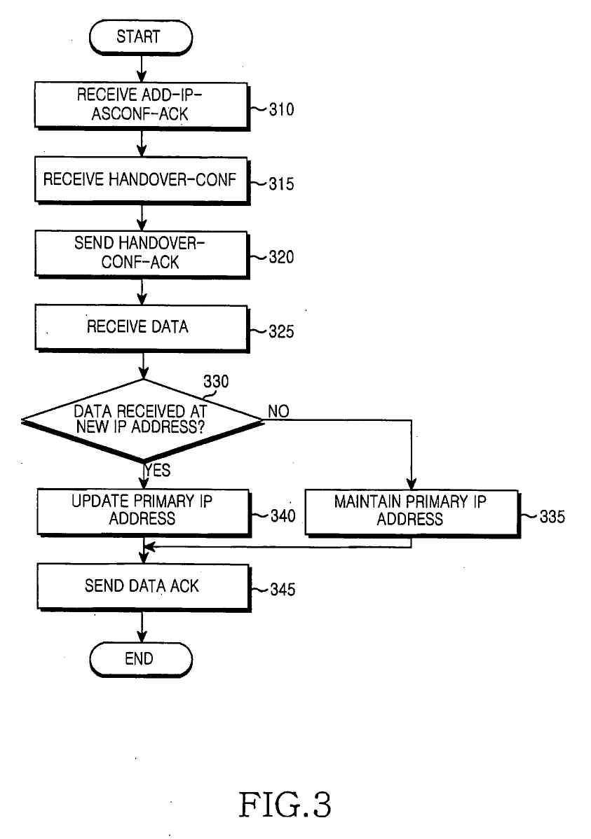

FIG. 3 is a flowchart illustrating the MN's operation for data transmission under a seamless handover environment according to the present invention.

Referring to FIG. 3, after a handover from the first area 210 (area 1) to the second area 220 (area 2), the MN 260 receives an ADD-IP-ASCONF-ACK message in response to an ADD-IP-ASCONF message sent to the CN 270 in step 310.

Upon receipt of a HANDOVER-CONF message from the CN 270 in step 315, it replies with a HANDOVER-CONF-ACK message in step 320. The HANDOVER-CONF message is a message confirming the handover of the MN 260 and the HANDOVER-CONF-ACK message is a response message for the HANDOVER-CONF message, indicating whether the reception of the HANDOVER-CONF message has failed or was successful.

In step 325, the MN 260 receives data from the CN 270. Then the MN 260 monitors reception of the data at a new IP address acquired after the handover in step 330.

If the data is not received at the new IP address, the MN 260 maintains its primary IP address in step 335 and sends a DATA ACK message for the received data to the CN 270 in step 345.

If the data is received at the new IP address, the MN 260 updates the primary IP address to the new IP address in step 340 and sends the DATA ACK message for the received data to the CN 270 in step 345.

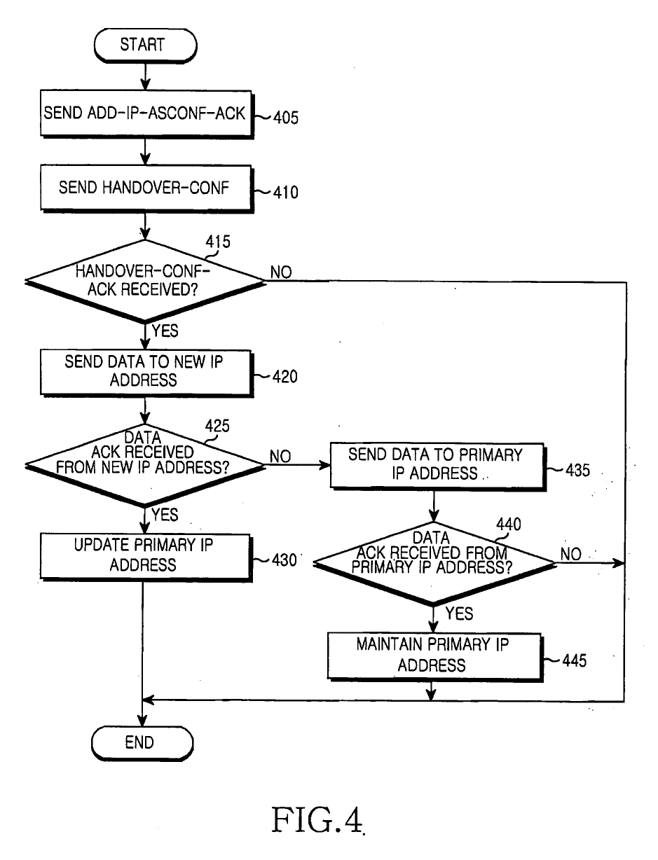

FIG. 4 is a flowchart illustrating the CN's operation for data transmission under the seamless handover environment according to the present invention.

Referring to FIG. 4, the CN 270 receives the ADD-IP-ASCONF message from the MN 260 when the MN 260 moves from area 1 to area 2 and replies with the ADD-IP-ASCONF-ACK message in step 405.

The CN 270 then sends the HANDOVER-CONF message to the MN 260 in step 410 and monitors reception of the HANDOVER-CONF-ACK message for the HANDOVER-CONF message from the MN 260 in step 415. If the HANDOVER-CONF-ACK message is not received in step 415, the process ends.

Upon receipt of the HANDOVER-CONF-ACK message in step 415, the CN 270 sends data to the new IP address of the MN 260 set in the HANDOVER-CONF message in step 420.

In step 425, the CN 270 monitors reception of the DATA ACK message for the data from the new IP address in step 425. Upon receipt of the DATA ACK message from the new IP address, the CN 270 updates the primary IP address of the MN 260 to the new IP address in step 430, and then the process ends.

If the DATA ACK message is not received from the new IP address, the CN 270 sends data to the primary IP address of the MN 260 in step 435. The primary IP address is included in the HANDOVER-CONF message.

In step 440, the CN 270 monitors reception of the DATA ACK message from the primary IP address. If the DATA ACK message is not received, the process ends.

Upon receipt of the DATA ACK message form the primary IP address, the CN 270 maintains the primary IP address in step 445 and then ends the process of the present invention.

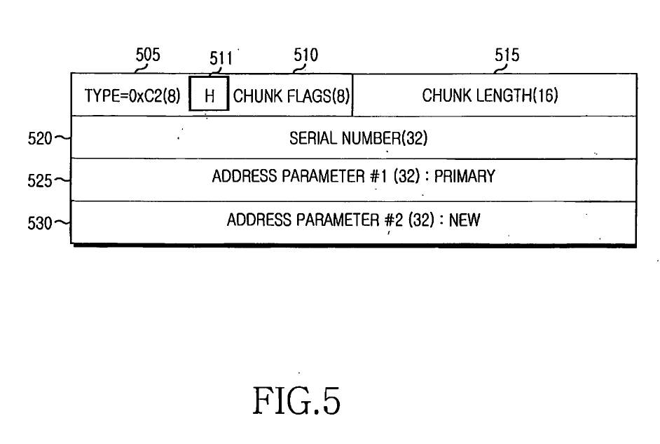

FIG. 5 illustrates the structure of the HANDOVER-CONF message according to the present invention. Each of specific numerals filled in the brackets denotes the size of a corresponding field, expressed as the number of bits. The terms “chunk” and “message” have the same meaning.

Referring to FIG. 5, a Type 505 indicates the type of the message, i.e. indicates that this message is a HANDOVER-CONF message. The type of the HANDOVER-CONF message is valued as “0xC2”.

A Chunk Flags 510 is reserved for setting a particular flag. In the present invention, one of the Chunk Flags 510 is used as a Handover (H) bit 511 indicating whether the handover is confirmed.

A Chunk Length 515 indicates the length of the message. A Serial Number 520 is the serial number of the message, ranging from 0 to 4294967295 (the number equals 2³²)

An Address Parameter #1 525 provides the primary IP address of the MN 260, and an Address Parameter #2 530 provides the new IP address of the MN 260 acquired after the handover.

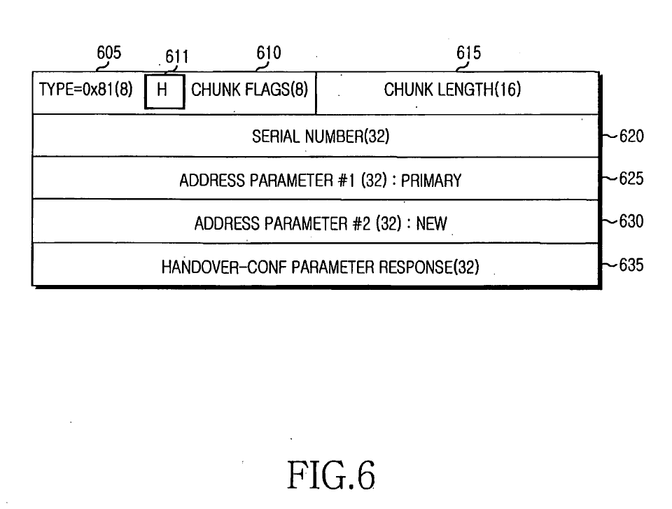

FIG. 6 illustrates the structure of the HANDOVER-CONF-ACK message according to the present invention. The HANDOVER-CONF-ACK message is a response for the HANDOVER-CONF message. Each of specific numerals filled in the brackets denotes the size of a corresponding field in the number of bits.

Referring to FIG. 6, a Type 605 indicates the type of the message, i.e. indicates that this message is a HANDOVER-CONF-ACK message. The Type 605 is set to “0x81” to indicate HANDOVER-CONF-ACK message.

A Chunk Flags 610 is reserved for setting a particular flag. In the present invention, one bit of the Chunk Flags 610 is used as an H bit 611 to indicate whether the handover is confirmed.

A Chunk Length 615 indicates the length of the message. A Serial Number 620 is the serial number of the message, ranging from 0 to 4294967295.

An Address Parameter #1 625 indicates the primary IP address of the MN 260 and an Address Parameter #2 630 indicates the new IP address of the MN 260 acquired after the handover.

A HANDOVER-CONF Parameter Response 635 indicates whether the reception of the HANDOVER-CONF message has failed or was successful.

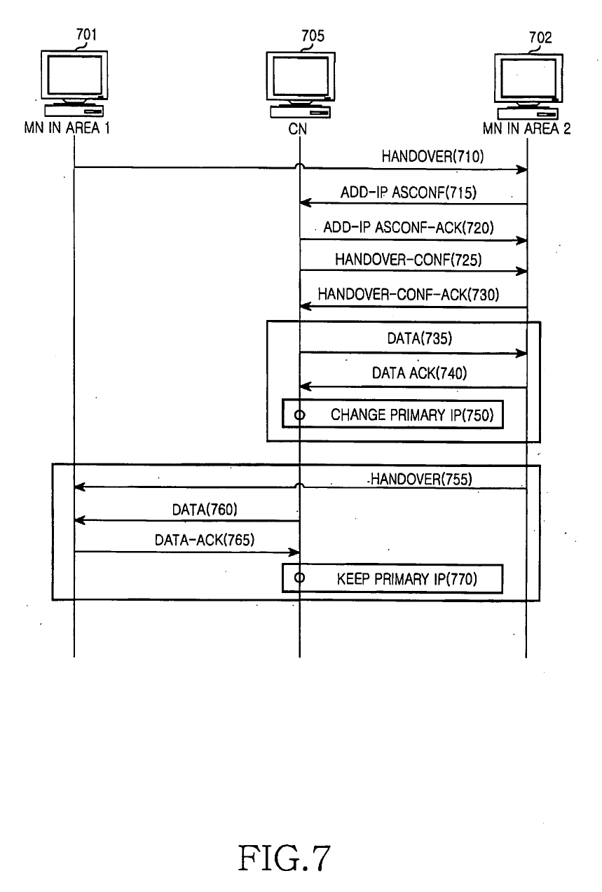

FIG. 7 illustrates a handover operation under the seamless handover environment according to the present invention.

Referring to FIG. 7, an MN 701 moves from area 1 to area 2 by handover in step 710.

The MN 701 in area 2 (newly denoted by a reference numeral 702), i.e. the MN 702, acquires a new IP address and notifies a CN 705 of the handover by an ADD-IP-ASCONF message in step 715.

The CN 705 replies to the MN 702 with an ADD-IP-ASCONF-ACK message in step 720 and then sends a HANDOVER-CONF message confirming the handover to the MN 702 in step 725.

Upon receipt of the HANDOVER-CONF message, the MN 702 replies to the CN 705 with a HANDOVER-CONF-ACK message in step 730.

In step 735, the CN 705 sends data to the new IP address of the MN 702 set in the HANDOVER-CONF message.

The MN 702 sends a DATA ACK message for the data to the CN 705 in step 740. Upon receipt of the DATA ACK message, the CN 705 updates the primary IP address of the MN 702 to the new IP address of the MN 702 in step 750.

If the CN 705 fails to receive the DATA ACK message and the MN 702 performs a handover back to area 1 in step 755, the CN 705 sends data to the primary IP address in step 760.

The MN 701 in area 1 sends a DATA ACK message for the data sent to the primary IP address to the CN 705 in step 765. The CN 705 maintains the primary IP address of the MN 701 in step 770 and ends the process of the present invention.

In accordance with the present invention as described above, when an MN moves to a new network area by handover and thus acquires a new IP address, it notifies a CN of the new IP address and the handover is confirmed by the CN. Then the CN keeps or changes the primary IP address of the MN for data transmission, considering the handover. Therefore, the MN seamlessly communicates with the CN with minimized data loss even under a handover environment.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A handover method in a Mobile Node (MN) in a network using a Stream Control Transport Protocol (SCTP), comprising the steps of:
notifying a Correspondent Node (CN) of a handover after the handover occurs;
receiving a handover confirm message from the CN and sending a response message for the handover confirm message to the CN;
checking a recipient Internet Protocol (IP) address at which data is received from the CN; and
changing a primary IP address of the MN to a new IP address, if the recipient IP address is the new IP address.

2. The handover method of claim 1, further comprising maintaining the primary IP address, if the recipient IP address is the primary IP address.

3. The handover method of claim 1, wherein the notifying step comprises sending an IP address add message to the CN and receiving a response message for the IP address add message from the CN.

4. The handover method of claim 1, wherein the handover confirm message includes a message type, handover indication information, a message length, a message serial number, the primary IP address, and the new IP address that the MN has acquired after the handover.

5. The handover method of claim 1, wherein the response message for the handover confirm message includes a message type, handover indication information, a message length, the new IP address acquired from the handover confirm message, and information indicating a processing result of the handover confirm message.

6. A handover method in a Correspondent Node (CN) in a network using a Stream Control Transport Protocol (SCTP), comprising the steps of:
receiving notification of a handover from a Mobile Node (MN) and sending a response message to the MN;
sending a handover confirm message to the MN;
receiving a handover confirm response message for the handover confirm message from the MN and sending data to a new Internet Protocol (IP) address;
updating a primary IP address of the MN to the new IP address, if a data response message for the data is received from the new IP address; and
sending the data to the primary IP address, if the data response message for the data is not received from the new IP address.

7. The handover method of claim 6, further comprising maintaining the primary IP address, if a data response message for the data is received from the primary IP address.

8. The handover method of claim 6, wherein the notification and response message sending step comprises receiving an IP address add message from the MN and sending an IP address add response message to the MN.

9. The handover method of claim 6, wherein the handover confirm message includes a message type, handover indication information, a message length, a message serial number, the primary IP address, and the new IP address that the MN has acquired after the handover.

10. The handover method of claim 6, wherein the handover confirm response message includes a message type, handover indication information, a message length, the new IP address acquired from the handover confirm message, and information indicating a processing result of the handover confirm message.

11. A method of transmitting data in a Correspondent Node (CN) in a network using a Stream Control Transport Protocol (SCTP), comprising the steps of:
sending data to a new Internet Protocol (IP) address of a Mobile Node (MN); and
updating the IP address of the MN to the new IP address, upon receipt of a response message for the data from the MN at the new IP address, and continuing data transmission.

12. The method of claim 11, further comprising:
sending data to a primary IP address of the MN, if the CN does not receive the response for the data sent to the new IP address; and
maintaining the primary IP address, upon receipt of a response for the data from the MN at the primary IP address.

13. A method of setting a primary Internet Protocol (IP) address in a Correspondent Node (CN) in a network using a Stream Control Transport Protocol (SCTP), comprising the steps of:
confirming a handover of a Mobile Node (MN) and sending data to a new IP address of the MN; and
updating a primary IP address of the MN to the new IP address, upon receipt of a response for the data from the MN at the new IP address.

14. The method of claim 13, further comprising:
sending data to the primary IP address if the CN does not receive the response for the data sent to the new IP address; and
maintaining the primary IP address, upon receipt of a response for the data from the MN at the primary IP address.

15. A Mobile Node (MN) in a network using a Stream Control Transport Protocol (SCTP), comprising:
means for notifying a Correspondent Node (CN) of a handover after the handover occurs;
means for receiving a handover confirm message from the CN and sending a response message for the handover confirm message to the CN;
means for checking a recipient Internet Protocol (IP) address at which data is received from the CN; and
means for changing a primary IP address of the MN to a new IP address, if the recipient IP address is the new IP address.

16. The Mobile Node of claim 15, further comprising means for maintaining the primary IP address, if the recipient IP address is the primary IP address.

17. A Correspondent Node (CN) in a network using a Stream Control Transport Protocol (SCTP), comprising:
means for receiving notification of a handover from a Mobile Node (MN) and sending a response message to the MN;
means for sending a handover confirm message to the MN;
means for receiving a handover confirm response message for the handover confirm message from the MN and sending data to a new Internet Protocol (IP) address;
means for updating a primary IP address of the MN to the new IP address, if a data response message for the data is received from the new IP address; and
means for sending the data to the primary IP address, if the data response message for the data is not received from the new IP address.

18. The Correspondent Node of claim 17, further comprising means for maintaining the primary IP address, if a data response message for the data is received from the primary IP address.

19. A Correspondent Node (CN) in a network using a Stream Control Transport Protocol (SCTP), comprising:
means for sending data to a new Internet Protocol (IP) address of a Mobile Node (MN); and
means for updating the IP address of the MN to the new IP address, upon receipt of a response message for the data from the MN at the new IP address, and continuing data transmission.

20. A Correspondent Node (CN) in a network using a Stream Control Transport Protocol (SCTP), comprising:
means for confirming a handover of a Mobile Node (MN) and sending data to a new IP address of the MN; and
means for updating a primary IP address of the MN to the new IP address, upon receipt of a response for the data from the MN at the new IP address.
